(19) United States
(12) Patent Application Publication
(10) Pub. No.: US 2017/0170715 A1
(43) Pub. Date: Jun. 15, 2017

(54) METHOD OF CONTROLLING AN INVERTER

(71) Applicant: ROLLS-ROYCE plc, London (GB)

(72) Inventors: Mohamed HM SATHIK, Singapore (SG); Chandana GAJANAYAKE, Singapore (SG); Sivakumar NADARAJAN, Singapore (SG); Bikramjit S. BHANGU, Singapore (SG); Amit K. GUPTA, Singapore (SG)

(73) Assignee: ROLLS-ROYCE plc, London (GB)

(21) Appl. No.: 15/348,553

(22) Filed: Nov. 10, 2016

(30) Foreign Application Priority Data
Dec. 10, 2015 (GB) 1521732.6

(51) Int. Cl. H02M 1/32; H02H 3/38; H02H 7/122; H02M 7/537

(52) U.S. Cl. CPC H02M 1/32; H02M 7/537; H02H 3/38; H02H 7/1227

(57) ABSTRACT

A method of controlling an inverter, in which the inverter includes a single-phase inverter arrangement having a complementary pair of power switches, including the steps of: controlling the complementary pair of power switches with a modulating signal to output an AC signal; monitoring a collector-emitter voltage of each of the pair of power switches; if the collector-emitter voltage exceeds a predetermined value, the corresponding one of the pair of power switches is judged to be in a short circuit condition; and if either one of the pair of power switches is judged to be in a short circuit condition, executing a shutdown operation to switch off the corresponding one of the pair of power switches.

This disclosure claims the benefit of UK Patent Application No. 1521732.6, filed on 10 Dec. 2015, which is hereby incorporated herein in its entirety.

### FIELD OF THE DISCLOSURE

The present disclosure relates to a method of controlling an inverter and particularly, but not exclusively, to a method of reducing the voltage, current and thermal stress amongst devices in a power converter, such as a DC to AC converter, during a fault condition.

### BACKGROUND TO THE DISCLOSURE

Power electronics is a technology that facilitates electrical energy conversion between source and load based on the combined functionality of energy systems, electronics and control. The use of power electronics has been widely seen in various applications, such as aerospace, military, automotive, computing etc., for proper and energy efficient operation.

In power electronics systems, the conversion process begins when the controller, which is a low-power digital or analogue electronic circuit, operates the power converter/switches according to a modulation strategy.

Power switches, such as insulated-gate bipolar transistors (IGBT) or metal-oxide-semiconductor field-effect transistors (MOSFET), are one of the key components in power electronic systems and their robustness and reliability determine the performance and availability of the power system.

Over the years, there has been continuous improvement on the design of power switches in order to make them more robust and reliable for industrial applications.

However, thermal management of power switches has been a challenge, especially in high ambient operating temperature environments. Due to the non-ideal characteristics of power switches (for example, internal resistance and parasitic capacitances and inductances), power losses are seen (typically referred to as conduction and switching losses) during operation of the power switches.

Losses in a power switch cause the junction temperature to increase. As the power switch is heated above its rated operating junction temperature, its reliability will typically be affected as every 10 degree Celsius increment above the rated temperature will reduce the lifetime of the power switch by half.

In order to reduce power losses in power switches, various methods have been proposed. These methods can be classified into hardware-based and control-based solutions. Hardware-based solutions are generally based on the addition of resonant tanks into the system to enable zero voltage or zero current switching of the power switches, leading to reduced switching losses. However, the use of resonant tanks increases the circulating current in the system, leading to the increase of conduction losses that may offset the reduction in switching losses. In addition, the inclusion of resonant tanks increases the complexity in system analysis.

A conventional IGBT device is controlled using a gate driver circuit comprising a gate resistor, low impedance output buffers, and a digital control unit that drives the buffers. The gate resistors are utilized to limit the gate current. The gate driver circuit commonly includes a short circuit detection and protection protocol. Typically, this short circuit detection is based on monitoring the gate voltage, or detecting desaturation in the collector to emitter leg.

On detection of a short circuit or over current condition, the power module is protected by quickly reducing the gate voltage to zero. This effectively switches the power module to an off-state. Clamp circuits, sensing diodes and gate voltage pattern analyser are examples of solutions used to collapse the gate voltage to a predefined threshold value upon detection of a fault. The gate voltage is then held at this value for a period of time before making a decision on the severity of the fault and subsequently reducing the gate voltage to zero.

However, these topologies experience a sudden decrease in the gate voltage which induces transients across the collector-emitter voltage. Such voltage spikes can lead to device latch up or in some instances can potentially damage the power module. In addition, the increased potential stress across the device during this period will also increase the power loss (in particular the switching loss) causing an excessive rise in the device junction temperature and further stressing the device.

### STATEMENTS OF DISCLOSURE

According to a first aspect of the present disclosure there is provided a method of controlling an inverter, the inverter including a single-phase inverter arrangement comprising a complementary pair of power switches, the method comprising the steps of:
controlling the complementary pair of power switches with a modulating signal to output an AC signal;
monitoring a collector-emitter voltage of each of the pair of power switches;
if the collector-emitter voltage exceeds a predetermined value, the corresponding one of the pair of power switches is judged to be in a short circuit condition; and
if either one of the pair of power switches is judged to be in a short circuit condition, executing a shutdown operation to switch off the corresponding one of the pair of power switches.

The method of the disclosure detects a short circuit fault in a power switch, and controls the gate voltage to limit the fault current and so minimising voltage or thermal stress on the power switch.

The control of the gate voltage ensures that the power switch is turned off with the Short Circuit Withstand Time (SCWT) of the power switch.

Accordingly, a control technique is provided that can improve the reliability and availability of, for example, power switches in a power electronics system without any modification of the hardware design. The thermal stresses of power switches in a power electronic system can be reduced and evenly distributed. This can significantly reduce the possibility of device failure due to thermal stress and improves the reliability of the system.

The method of the disclosure uses a de-saturation technique to accurately detect and identify short circuit faults in the power switch. A de-saturation condition is defined by the voltage across the collector to emitter terminals of the power switch being greater than a predetermined voltage, while the gate to emitter voltage of the power switch is high.

This predetermined voltage may be in the range of 5 to 8 v.

The de-saturation condition indicates that the current through the power switch has exceeded the normal operating level.

In alternative embodiments of the disclosure, the step of judging whether either one of the pair of power switches is in a short circuit condition may be achieved by monitoring another circuit parameter such as, for example, gate charge.

Optionally, the step of judging whether either one of the pair of power switches is in a short circuit condition is performed over a first predetermined fault assessment time period.

By performing the step of judging whether either one of the pair of power switches is in a short circuit condition, over a predetermined period of time, the method of the disclosure can ensure the integrity of the fault. This makes the method more robust and reliable for a user.

Optionally, the first fault assessment time period is less than 3 μs.

By ensuring that the step of judging whether either one of the pair of power switches is in a short circuit condition, is completed in less than 3 μs, the method ensures that the power switch is turned off quickly so as to avoid damage to the power switch.

Optionally, the step of judging whether either one of the pair of power switches is in a short circuit condition, comprises the additional step of:
judging whether either one of the pair of power switches is in an over current fault condition,
and the step of if either one of the pair of power switches is judged to be in a short circuit condition, executing a shutdown operation to switch off the corresponding one of the pair of power switches, comprises the step of:
if either one of the pair of power switches is judged to be in an over current fault condition, executing a shutdown operation to switch off the corresponding one of the pair of power switches.

Optionally, the step of judging whether either one of the pair of power switches is in an over current fault condition is performed over a second predetermined fault assessment time period.

By performing the step of judging whether either one of the pair of power switches is in an over current fault condition, over a predetermined period of time, the method of the disclosure can ensure the integrity of the fault. This makes the method more robust and reliable for a user.

Optionally, the second fault assessment time period is less than 10 μs.

By ensuring that the step of judging whether either one of the pair of power switches is in an over current fault condition, is completed in less than 10 μs, the method ensures that the power switch is turned off quickly so as to avoid damage to the power switch.

Optionally, the step of executing a shutdown operation to switch off the corresponding one of the pair of power switches comprises the step of:
increasing the input impedance of a respective one of the pair of power switches to thereby reduce the gate voltage of the corresponding one of the pair of power switches.

Increasing the input impedance to the power switch enables the power switch to be safely and rapidly turned off, so minimising the risk of damage to the power switch.

Optionally, wherein the step of increasing the input impedance of a respective one of the pair of power switches to thereby reduce the gate voltage of the corresponding one of the pair of power switches, comprises the additional step of:
linearly decreasing the gate voltage to softly turn off the corresponding one of the pair of power switches.

Reducing the gate voltage in a linear fashion enables the method of the disclosure to softly turn off the corresponding one of the power switches. This makes the method of the disclosure more effective at switching off the inverter in response to a fault condition.

Optionally, the step of increasing the input impedance of a respective one of the pair of power switches to thereby reduce the gate voltage of the corresponding one of the pair of power switches comprises the step of:
disabling a pulse-width modulated signal to a driver circuit feeding a gate terminal of the corresponding one of the pair of power switches, to enable the safe shutdown of the corresponding one of the power switches.

The step of disabling a pulse-width modulated signal to a driver circuit feeding a gate terminal ensures the reliable increase of the

According to a second aspect of the present disclosure there is provided a computer program that, when read by a computer, causes performance of the method according to the first aspect.

According to a third aspect of the present disclosure there is provided a non-transitory computer readable storage medium comprising computer readable instructions that, when read by a computer, cause performance of the method according to the first aspect.

According to a fourth aspect of the present disclosure there is provided a signal comprising computer readable instructions that, when read by a computer, cause performance of the method according to the first aspect.

Other aspects of the disclosure provide devices, methods and systems which include and/or implement some or all of the actions described herein. The illustrative aspects of the disclosure are designed to solve one or more of the problems herein described and/or one or more other problems not discussed.

### BRIEF DESCRIPTION OF THE DRAWINGS

There now follows a description of an embodiment of the disclosure, by way of non-limiting example, with reference being made to the accompanying drawings in which:

FIG. 1 shows a three phase inverter to which the present disclosure is applicable;

FIG. 2A shows an example of the respective voltage waveforms used in a typical sinusoidal pulse width modulation technique;

FIG. 2B shows the resultant terminal voltage for inverter leg A shown in FIG. 1;

FIG. 2C shows the resultant terminal voltage for inverter leg B shown in FIG. 1;

FIG. 2D shows the fundamentally sinusoidal voltage obtained between the respective terminals of legs A and B of FIG. 1;

FIG. 3 shows a flowchart exemplifying an embodiment of the present disclosure;

FIG. 4 shows the gate voltage and the collector-emitter voltage characteristics of an embodiment of the present disclosure;

FIG. 5 shows a schematic arrangement of a short circuit protection circuit according to an embodiment of the present disclosure;

FIGS. 6A to 6D show simulation characteristics of a ‘soft-gate’ control methodology according to an embodiment of the present disclosure, together with the corresponding characteristics of a ‘two-step’ control methodology according to the prior art;

FIG. 7 shows a normal operating characteristic for a typical IGBT module;

FIG. 8 shows the signal characteristics of FIG. 7 in which the method of an embodiment of the present disclosure, providing short circuit protection, has been implemented;

FIG. 9 shows a detailed view of the short circuit event highlighted in the characteristic of FIG. 8;

FIG. 10 shows the signal characteristics of FIG. 7 during a fault under load condition; and

FIG. 11 shows the signal characteristic of FIG. 7 during a short circuit under hard switch fault condition.

It is noted that the drawings may not be to scale. The drawings are intended to depict only typical aspects of the disclosure, and therefore should not be considered as limiting the scope of the disclosure. In the drawings, like numbering represents like elements between the drawings.

### DETAILED DESCRIPTION

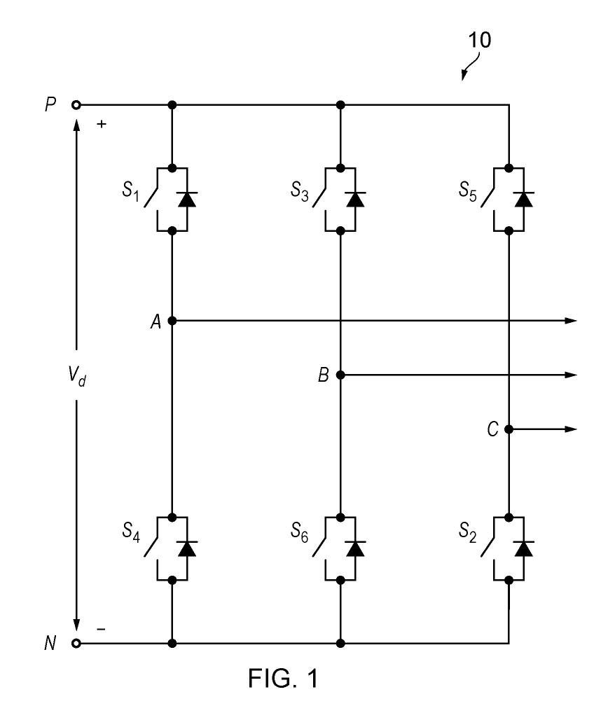

The present disclosure is applicable to three-phase power converter systems that use pulse-width modulation strategy to control the switching of power switches, for example. An example of a (generalised) suitable three-phase power converter system is shown in FIG. 1. The three-phase converter 10, also referred to as an inverter, shown in FIG. 1 is used to explain the concept of this disclosure.

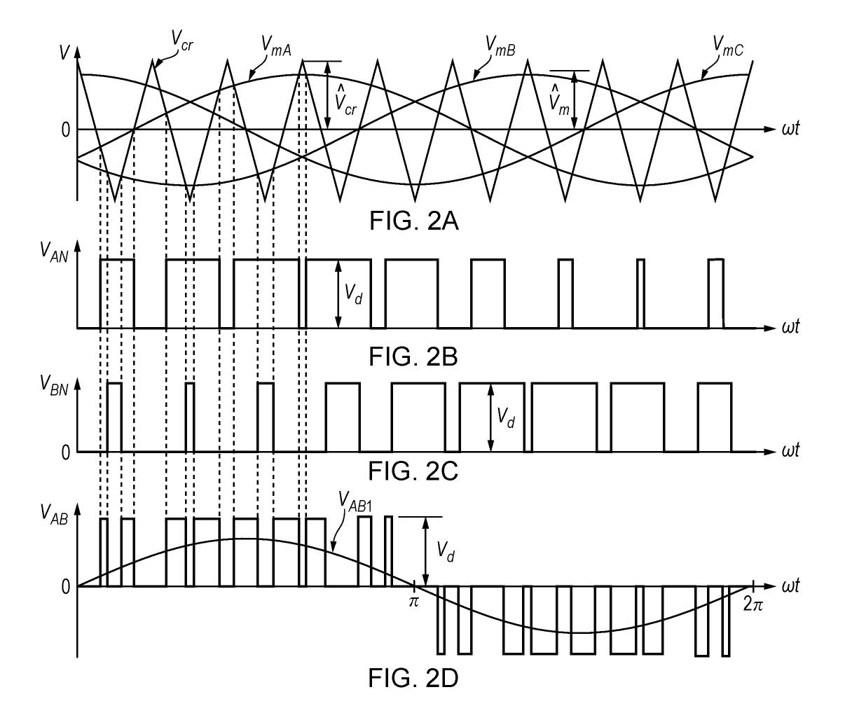

In general, to generate AC output waveforms from the DC supply V_{d} in FIG. 1, power switches S1-S6 of the inverter are turned on and off according to a sequence specified by a modulation strategy. For example, a sinusoidal pulse-width modulation strategy can be applied, which is a strategy known to the skilled person. An example is shown in the uppermost plot shown in FIG. 2, where V_{mA}, V_{mB}, V_{mC} are the three-phase sinusoidal modulating waves, and V_{cr} is a triangular carrier wave. The gating signals for a conventional two-level inverter (for example, as shown in FIG. 1) operated using PWM can be derived as follows. The operation of switches S1 to S6 is determined based on a comparison of the modulating waves (V_{mA}, V_{mB}, V_{mC}) with the carrier wave (V_{cr}). When for example V_{mA} is greater than or equal to V_{cr}, the upper switch S1 in inverter leg A is turned on. The lower switch S4 operates in a complementary manner and thus is switched off. The resultant inverter terminal voltage V_{AN}, which is the voltage at the phase A terminal with respect to the negative DC-link bus “N”, is equal to the DC voltage V_{d}. When V_{mA} is less than V_{cr}, S4 is on and S1 is off, leading to V_{AN}=0. The same methodology is applied to generate the inverter terminal voltages V_{BN} and V_{CN}.

The output waveforms generated by the inverter are composed of discrete values with fast transition, as shown in the lower plots of FIG. 2. Even though the output waveform is not truly sinusoidal, the fundamental component of the output waveform (for example, V_{AB}) behaves as a sinusoid.

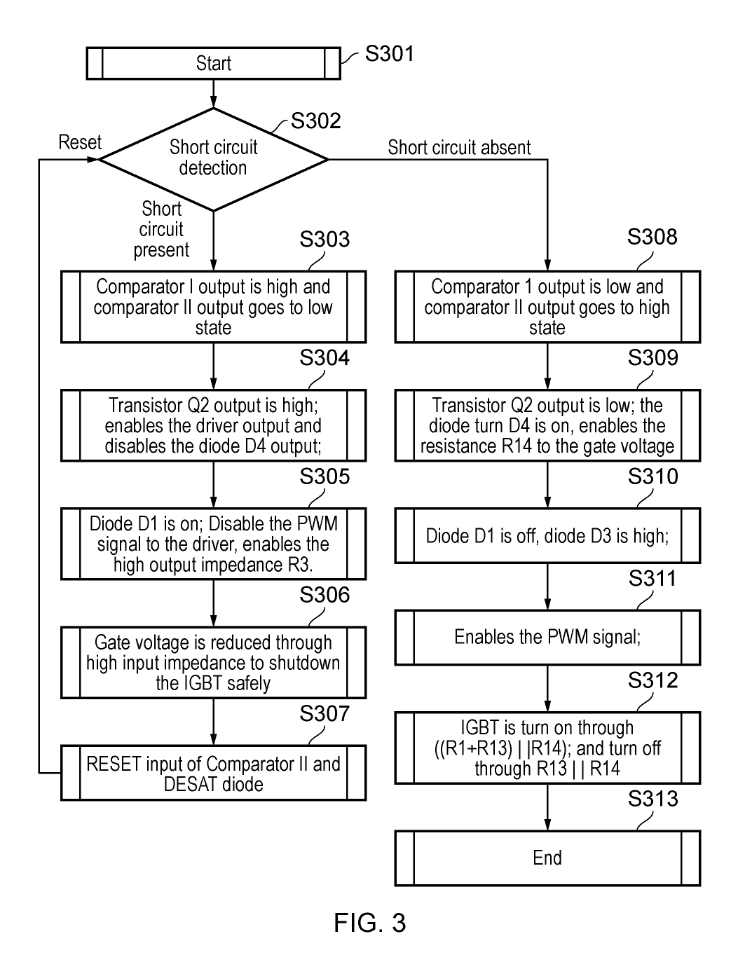

FIGS. 3 to 5 illustrate an embodiment of the method of controlling an inverter according to the present disclosure.

FIG. 3 shows a flow chart embodying one or more aspects, and optional features, of the method of the present disclosure. FIG. 3 describes the methodology of an embodiment of the present disclosure used to detect a short circuit fault in a power switch for a three-phase inverter as shown in FIG. 1.

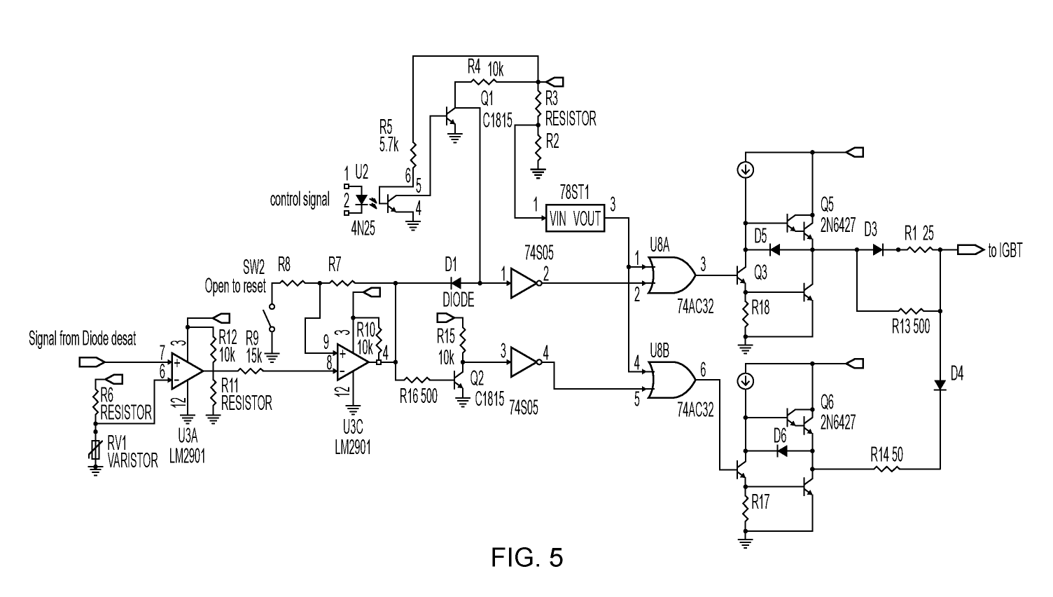

FIG. 5 shows an example schematic diagram of a proposed short circuit protection circuit embodying the method of the present disclosure.

The short circuit protection circuit consist of a desaturation diode, two comparators U3A and U3C (LM2901), and a driver (UC3708) connected to the power switch through gate resistors. A separate control circuit from a digital signal processor is connected to the driver through an opto-coupler in order to protect the controller from noise and ripples in the driver circuit. The pulse width modulation signals from the digital signal processor enables or disables the power switch conduction.

It is to be understood that the method of the present disclosure is not limited to a three-phase inverter. Indeed, the method of the present disclosure is applicable to any poly-phase power converter, for example an inverter.

At step S301, the method starts.

At step S302, a judgement is made if either one of the power switches is in a short circuit condition. This judgement is based upon the voltage across the collector to emitter terminals of the power switch, which is monitored to determine if a short circuit condition exists in the power switch. If the voltage across the collector to emitter terminals of the power switch rises above a critical voltage, the power switch is considered to be in a de-saturated condition.

In other words, the voltage across the collector-emitter increases above the normal on-state voltage (V_{CESAT}>3V).

In the present disclosure, this critical voltage is between 5 and 8 volts, and more particularly approximately 7 volts. In other embodiments, this critical voltage may be another particular value within the range of 5 to 8 volts.

When it is determined that a short circuit condition exists in one of the power switches, the method proceeds to step S303, and the left-hand branch of the flow diagram of FIG. 3.

At step S303, the increasing on-state voltage turns on the DESAT diode, which causes the output of the comparator U3A output to become high, and this positive signal from the comparator U3A causes the output of the comparator U3C to become low.

At step S304, the negative low signal from comparator U3C switches on diode D1.

This then, at step S305, disables the pulse-width modulated signal from the controller and enables the high gate discharge input impedance R13.

This high input impedance, at S306, then reduces the gate voltage to the power switch to shut down the power switch. The use of the high impedance resistor R13 allows the control of the gate voltage softly until the device switch off.

Step S307 then provides for a reset of the comparator U3C and the de-saturation diode, and the method returns to the judging step S302.

If it is determined that a short circuit condition does not exist in one of the power switches, the method proceeds to step S308, and the right-hand branch of the flow diagram of FIG. 3.

In step S308, under normal operating condition the de-saturation diode is normally low because there is no short circuit in the power switch. Consequently, the output of the comparator U3A is low, and concomitantly the output of the comparator U3C is high.

At step S309, the parallel connection of resistors R13&R14 provides a low gate input impedance that triggers the power switch to be enabled.

This allows deactivation of the diode D1 at step S310.

At step S313, the method may stop. However, it is preferred that the method returns to step S302, for example, after a pre-determined period of time.

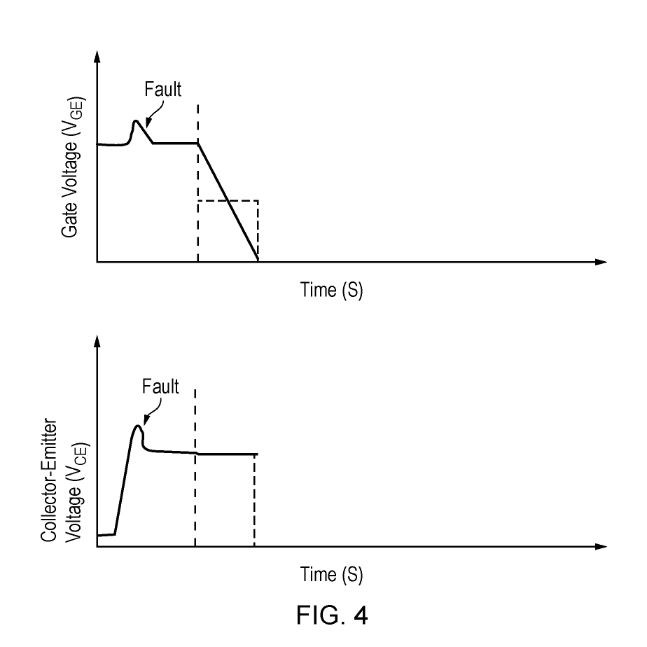

FIG. 4 shows the gate voltage and the collector-emitter voltage characteristics of a power switch arrangement controlled by an embodiment of the method of the present disclosure.

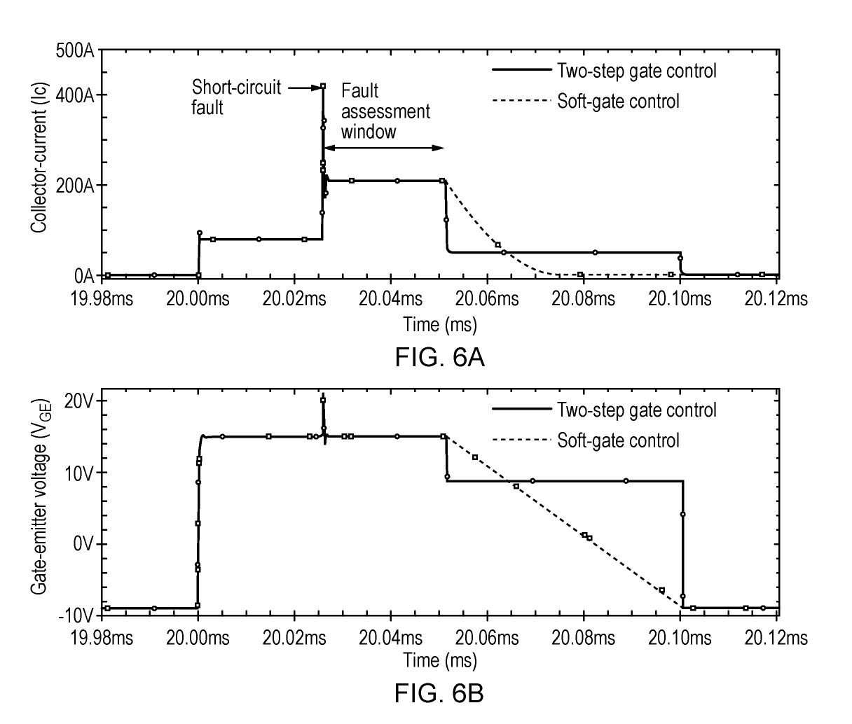

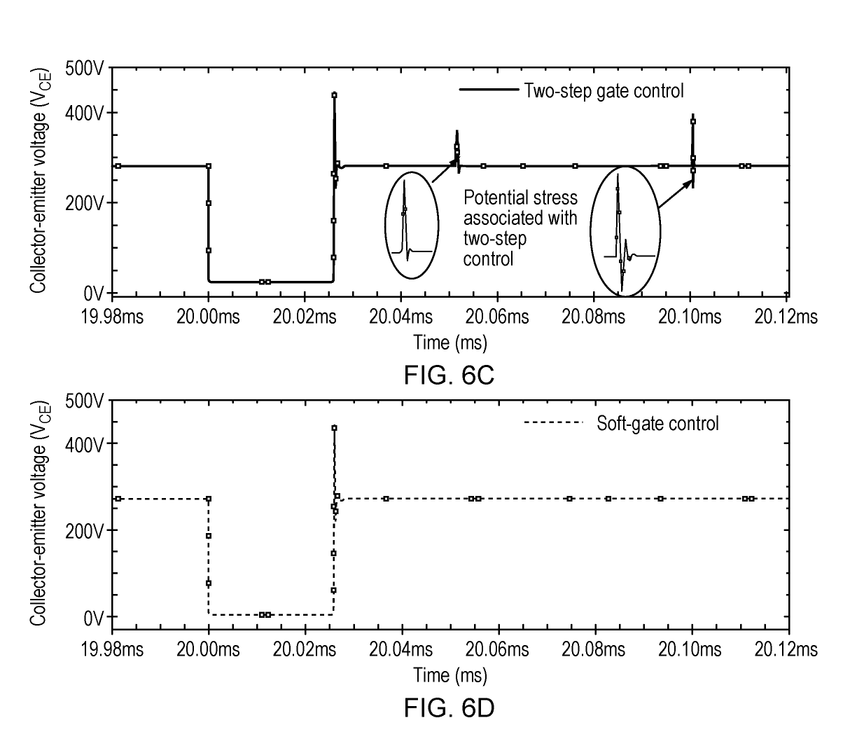

FIGS. 6A to 6D show a simulation comparison of a two-step control method (this is one of the prior art methods commonly used for the safe shutdown of power switches) with a soft-gate control method subjected to a short circuit fault condition (as in the present disclosure). The collector current I_{c} is continually monitored and in this case provides the fault signal. Note that this fault can be achieved through various other detection circuits. Upon the detection of a fault signal, the integrity of the fault is assessed (within the fault assessment window period), prior to taking actions to protect the power module. The gate voltage for two-step and soft-gate control shows the remedial action taken to protect the power module. Note that there is a large transient collector-emitter voltage stress induced across the device when employing two-step control. Such transient signals are not observed with the proposed solution which eliminates the potential and thermal stresses during the protection stage.

### Experimental Results and Analysis

Experimental results are presented for IGBT modules under hard-switched fault and fault under load conditions. The example IGBT modules used in the experiments are a 100 A 400V single module. For these experiments, a single IGBT chopper circuit was constructed with a resistive load. The circuit was energized with a constant power rating of 1 KW, and after 1 μs the load resistor were shorted using a relay switch.

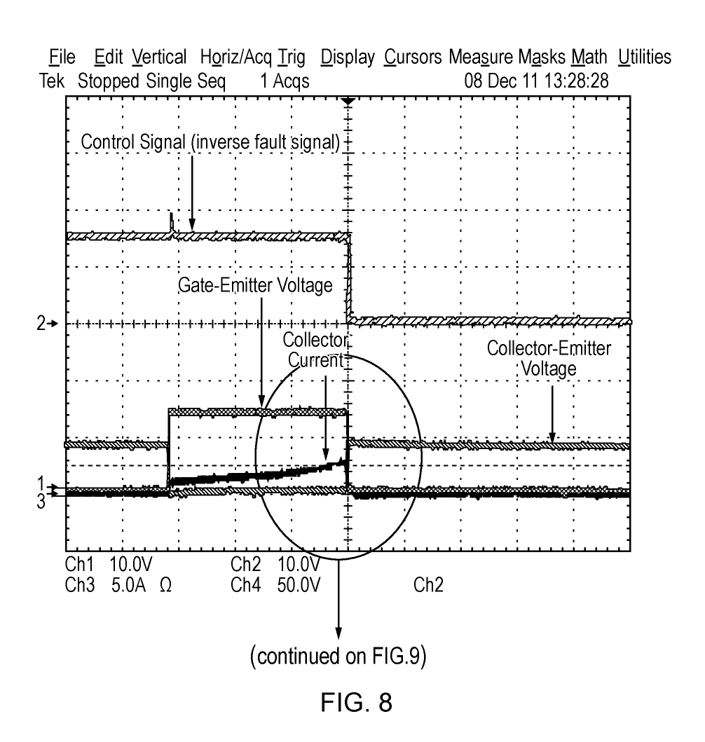

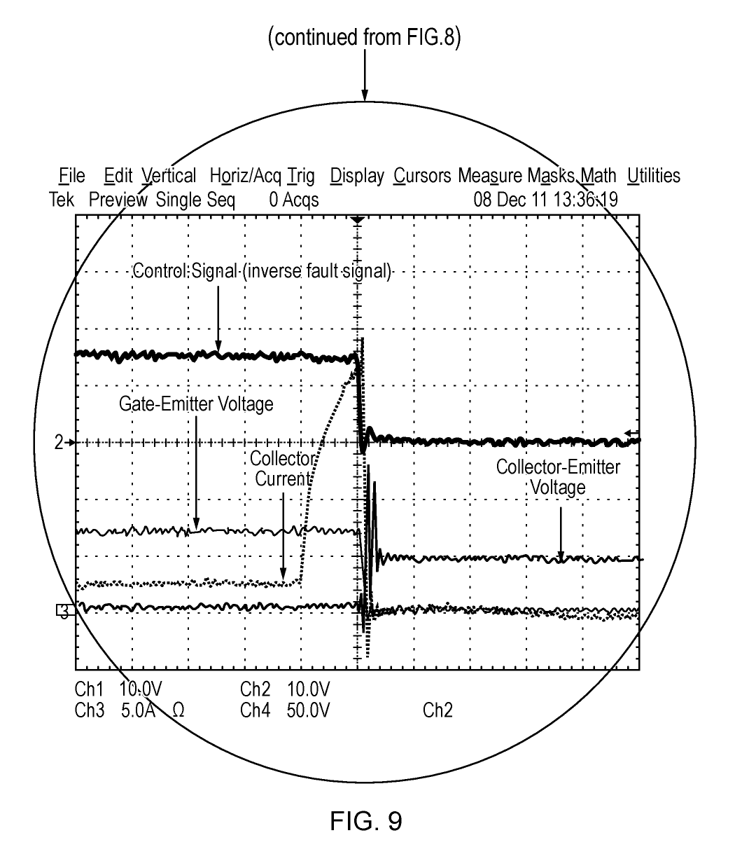

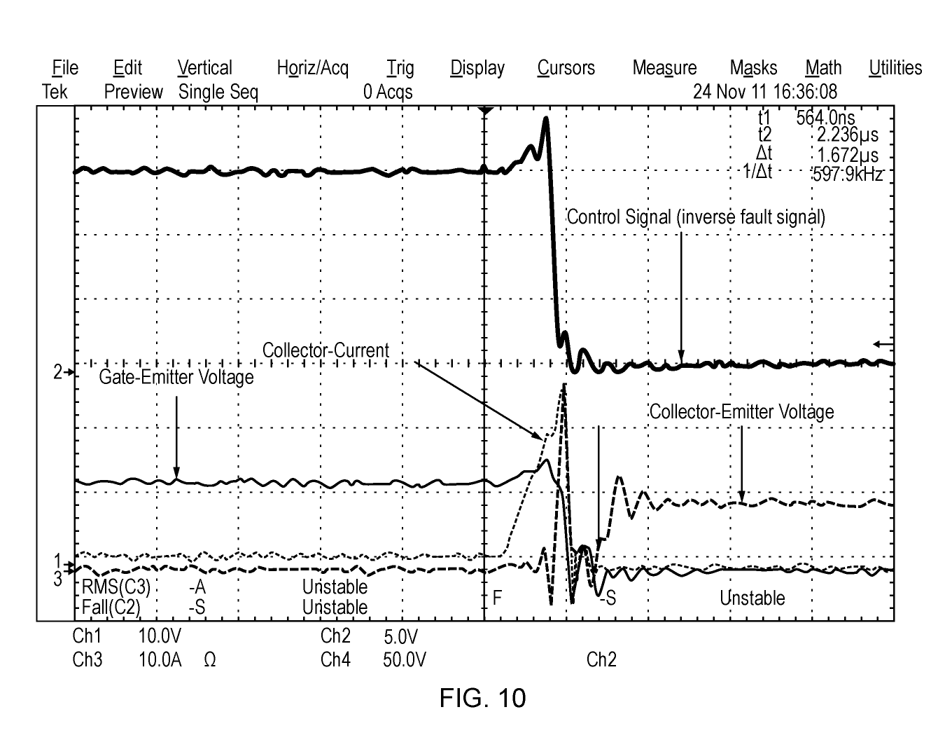

FIGS. 8, 9, 10 and 11 show the waveform of the IGBT short circuit under load, hard switch fault conditions, and driven by the proposed soft gate drive control method of the present disclosure.

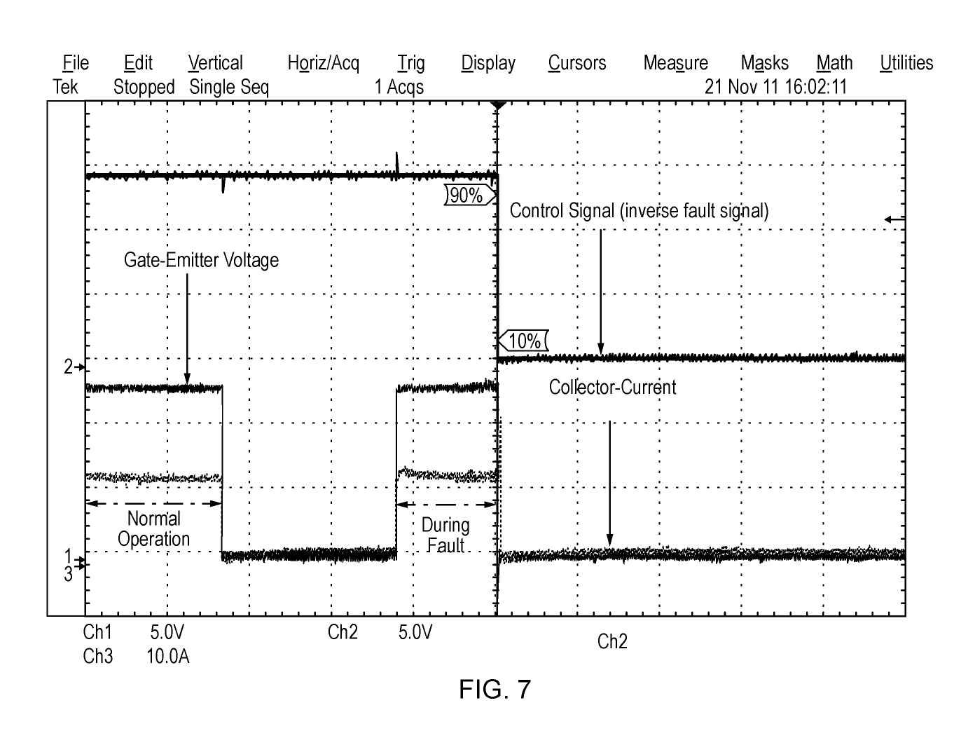

As shown in FIG. 7, during normal operating conditions, the control driver generates signal during on conduction and commutation state. This generated signal always stays high, and is labelled as control signal (i.e. inverse fault signal). During the fault condition the control signal goes low, the driver softly shuts down the IGBT, and sends the feedback to the controller.

FIGS. 8, 9 and 10 show that during the fault under load condition, the IGBT is protected within 3 μs. Here the falling time of the IGBT can be adjusted by the designing of suitable gate impedances and also it can adjust the voltage and current ripples.

The protection circuit proves that stress on the IGBT under fault current condition is minimized and provides a solution for improved protection of power modules by reducing the potential and thermal stress imposed during fault conditions. This will improve the reliability and performance of the power system.

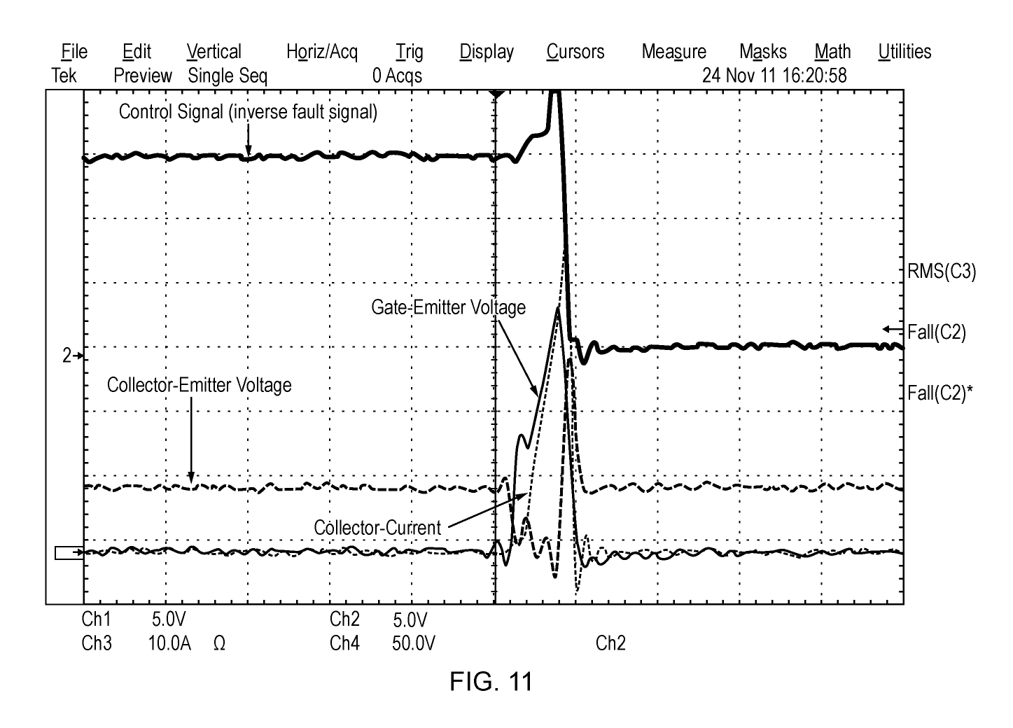

FIG. 11 shows that the experimental result of IGBT short circuit under hard switch fault condition. Here the fault happens when the device is turned on; the control signal goes low to turn off the IGBT softly within short circuit with standing time, the potential stress across the IGBT limited momentarily, there is no voltage oscillation or ripple across the IGBT once the device is shut downed safely.

The present disclosure is principally directed to the modulation techniques used in power converters (inverters) to control the operations of power switches, improving the reliability and extending the availability of the system by intelligently reducing the possibility of device failures due to thermal stress.

The solution provided by the present disclosure is applicable to both low and high power systems that employ power switches and implement high switching frequency operation. This includes motor drives, power converters, inverters and chopper drives, as examples.

The development of reliable and robust electrical systems is critical, especially for mission critical and safety critical applications such as aircraft and marine vessels. The present disclosure provides for improved reliability and availability of power electronics systems by reducing the possibility of device failure due to thermal stress.

Besides sinusoidal pulse-width modulation strategy, the present disclosure can be used for other modulation strategies, such as space vector modulation, discrete pulse-width modulation, discontinuous pulse-width modulation etc.

The technique of the present disclosure may also be used with other short circuit detection methods that employ alternative monitoring parameters such as, for example, gate charge.

Also, the present disclosure can be further improved by combining with cooling systems used in power inverters. If such cooling systems are developed with active control capability, the control operation of the present disclosure can be aligned with the active control of the cooling system to effectively managing the operating temperature of the power switches.

In addition to a three-phase two-level inverter, the present disclosure can be applied to control the power switches of multi-level power converter systems, which are mainly used in high voltage high power applications. For such systems, the present disclosure is able to distribute thermal stress of the power switches across the system evenly. In addition, due to the higher number of power switches required in multilevel power converter system, the benefits of reducing the thermal stress of any individual failing switch in a multilevel inverter is a significant improvement over the prior art.

Except where mutually exclusive, any of the features may be employed separately or in combination with any other features and the disclosure extends to and includes all combinations and sub-combinations of one or more features described herein.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to a person of skill in the art are included within the scope of the disclosure as defined by the accompanying claims.

1. A method of controlling an inverter, the inverter including a single-phase inverter arrangement comprising a complementary pair of power switches,
the method comprising the steps of:
controlling the complementary pair of power switches with a modulating signal to output an AC signal;
monitoring a collector-emitter voltage of each of the pair of power switches;
if the collector-emitter voltage exceeds a predetermined value, the corresponding one of the pair of power switches is judged to be in a short circuit condition; and
if either one of the pair of power switches is judged to be in a short circuit condition, executing a shutdown operation to switch off the corresponding one of the pair of power switches.

2. The method of controlling an inverter as claimed in claim 1, wherein the step of judging whether either one of the pair of power switches is in a short circuit condition is performed over a first predetermined fault assessment time period.

3. The method of controlling an inverter as claimed in claim 2, wherein the first fault assessment time period is less than 3 μs.

4. The method of controlling an inverter as claimed in claim 1, wherein the step of judging whether either one of the pair of power switches is in a short circuit condition, comprises the additional step of:
judging whether either one of the pair of power switches is in an over current fault condition,
and the step of if either one of the pair of power switches is judged to be in a short circuit condition, executing a shutdown operation to switch off the corresponding one of the pair of power switches, comprises the step of:
if either one of the pair of power switches is judged to be in an over current fault condition, executing a shutdown operation to switch off the corresponding one of the pair of power switches.

5. The method of controlling an inverter as claimed claim 4, wherein
the step of judging whether either one of the pair of power switches is in an over current fault condition is performed over a second predetermined fault assessment time period.

6. The method of controlling an inverter as claimed in claim 5, wherein the second fault assessment time period is less than 10 μs.

7. The method of controlling an inverter as claimed in claim 1, wherein the step of executing a shutdown operation to switch off the corresponding one of the pair of power switches comprises the step of:
increasing the input impedance of a respective one of the pair of power switches to thereby reduce the gate voltage of the corresponding one of the pair of power switches.

8. The method of controlling an inverter as claimed in claim 7, wherein the step of increasing the input impedance of a respective one of the pair of power switches to thereby reduce the gate voltage of the corresponding one of the pair of power switches, comprises the additional step of:
linearly decreasing the gate voltage to softly turn off the corresponding one of the pair of power switches.

9. The method of controlling an inverter as claimed in claim 7, wherein the step of increasing the input impedance of a respective one of the pair of power switches to thereby reduce the gate voltage of the corresponding one of the pair of power switches comprises the step of:
disabling a pulse-width modulated signal to a driver circuit feeding a gate terminal of the corresponding one of the pair of power switches, to enable the safe shutdown of the corresponding one of the power switches.

10. A computer program that, when read by a computer, causes performance of the method as claimed in claim 1.

11. A non-transitory computer readable storage medium comprising computer readable instructions that, when read by a computer, cause performance of the method as claimed in claim 1.

12. A signal comprising computer readable instructions that, when read by a computer, cause performance of the method as claimed in claim 1.

13. The method of controlling an inverter as claimed in claim 8, wherein the step of increasing the input impedance of a respective one of the pair of power switches to thereby reduce the gate voltage of the corresponding one of the pair of power switches comprises the step of:
disabling a pulse-width modulated signal to a driver circuit feeding a gate terminal of the corresponding one of the pair of power switches, to enable the safe shutdown of the corresponding one of the power switches.
